(19) United States
(12) Patent Application Publication
(10) Pub. No.: US 2022/0289007 A1
(43) Pub. Date: Sep. 15, 2022

(54) DRIVE SYSTEM FOR A SPOILER ROOF ASSEMBLY OF A MOTOR VEHICLE AND SPOILER ROOF ASSEMBLY

(71) Applicant: BOS GmbH & Co. KG, Ostfildern (DE)

(72) Inventors: Thomas DINTNER, Nürtingen (DE); Martin PERSON, Ostfildern (DE)

(21) Appl. No.: 17/692,772

(22) Filed: Mar. 11, 2022

(30) Foreign Application Priority Data
Mar. 15, 2021 (DE) 102021202488.2

(51) Int. Cl. B60J 7/057; B60J 7/043; B60J 7/047

(52) U.S. Cl. CPC B60J 7/0573; B60J 7/043; B60J 7/047

(57) ABSTRACT

A drive system for a spoiler roof assembly of a motor vehicle, having a support bar connected to a movable roof part, a control mechanism engaging the support bar to shift the support bar between closed, ventilation and open positions, and a guide rail assembly in which the control mechanism is guided for longitudinal displacement. The control mechanism has a rear deployment lever coupled to the support bar by an upper point of articulation and mounted for pivoting between rest and deployed positions on a displaceable deployment carriage. A forced mechanical control shifts the deployment lever between the rest and deployed positions depending on displacement of the deployment carriage. The forced machanical control is formed by a control lever pivotably mounted at one end on the deployment lever and at the other end on a stationary bearing section of the guide rail assembly.

### CROSS-REFERENCE TO RELATED APPLICATION

This claims priority from German Application No. 10 2021 202 488.2, filed Mar. 15, 2021, the disclosure of which is hereby incorporated by reference in its entirety.

TECHNICAL FIELD

The invention relates to a drive system for a spoiler roof assembly of a motor vehicle, with a support bar which can be connected to a movable roof part, with a control mechanism which engages on the support bar in order to shift the support bar between a closed position, a ventilation position, and an open position, and with a guide rail assembly which is in a ready for use state fixed to the vehicle and in which the control mechanism is guided so that it can be displaced longitudinally, wherein the control mechanism has a rear deployment lever which is coupled to the support bar by means of an upper point of articulation and is mounted, so that it can pivot between a rest position and a deployed position, on a deployment carriage which can be displaced along the guide rail assembly, wherein a mechanical forced control is assigned to the deployment lever and shifts the deployment lever between the rest position and the deployed position depending on a displacement of the deployment carriage.

BACKGROUND AND SUMMARY

Such a drive system is known from WO 2020/143956 A1. The drive system is part of a spoiler roof assembly for a car. The spoiler roof assembly has a movable roof part which can be shifted between a closed position which seals shut the roof cut-out, an obliquely positioned ventilation position, and an open position in which it is moved over a fixed roof area. In order to shift the movable roof part, respective drive systems are provided on opposite longitudinal sides of the roof part which are coupled to each other synchronously in order to obtain a parallel and synchronous shifting of the opposite longitudinal sides of the roof part. Each drive system has a respective support bar which is rigidly connected to a corresponding longitudinal side. Engaging on the support bar is a control mechanism which has a front deployment mechanism and a rear deployment mechanism. The control mechanism is driven by a high-tensile, compression-resistant drive cable which is moved via an electric motor and a corresponding gear. The control mechanism is mounted displaceably in a guide rail assembly which is fixed to the roof and is part of a roof-side support frame which is rigidly connected to the roof of the car. The drive cable is mounted so that it can be displaced linearly in the guide rail assembly. The drive cable engages on a control carriage which is responsible both for movement of the front deployment mechanism and for movement of the rear deployment mechanism. The rear deployment mechanism has a deployment carriage which is mounted displaceably in the guide rail assembly and on which a deployment lever is mounted so that it can pivot between a rest position and a deployed position. The deployment lever is coupled to the support bar at an end region remote from the deployment carriage such that a deployment movement of the deployment lever forces the support bar to be raised. In order to shift the deployment lever depending on a displacement of the deployment carriage, a forced mechanical control system is assigned to the deployment lever and is formed, on the one hand, by a curved guide slide fixed to the roof and, on the other hand, by a slide pin provided on the deployment lever. The slide pin is guided in the curved slide guide. When the deployment carriage is shifted longitudinally, the deployment lever is consequently deployed outward or lowered downward by the forced guidance in the slide guide depending on the direction in which the deployment carriage is displaced. The deployment carriage is coupled by means of a coupling profile, depending on the position of the support bar, either to the control carriage or to a retaining receptacle, depending on whether it is intended for the deployment carriage to be displaced or immobilized in its displaced position.

The object of the invention is to provide a drive system and a spoiler roof assembly of the type mentioned at the beginning which have a simpler structure and mode of operation than in the prior art.

For the drive system, the object on which the invention is based is achieved by the mechanical forced control being formed by a control lever which is mounted so that it can pivot at one end on the deployment lever and at the other end on a bearing section which is stationary with respect to the guide rail assembly. The bearing section can be positioned on the guide rail assembly itself or on a different vehicle section which supports the guide rail assembly or is arranged so that it is stationary with respect to the latter, in particular a support frame for the guide rail assembly or a roof-side body shell section. The forced control is thus formed by a single component which is permanently connected to the deployment lever and the stationary bearing section of the guide rail assembly in the manner of a four-bar linkage with limited rotational movement. The control lever is advantageously formed by a flat, bar-like, or tab-like metal component. The solution according to the invention permits a considerably simplified structure of the rear deployment mechanism. Particularly robust and functionally reliable forced control of the deployment lever results in addition. The solution according to the invention is provided for a spoiler roof assembly of a motor vehicle, in which at least one movable roof part can be shifted from a closed position into a ventilation position and into an open position in which it is moved above a roof section situated behind it. The solution according to the invention is particularly advantageously suited for use in vehicle roofs of cars. The movable roof part is preferably designed as a transparent glass roof part. A fixed roof section of the spoiler roof assembly is preferably also designed as a transparent glass component. The drive system according to the invention can preferably be driven by means of a drive unit arranged in the roof region, in particular by means of an electric motor. It is also possible to generate driving force using a mechanical, hydraulic, or pneumatic drive unit. It is alternatively possible to assign manual activation in the form of a crank handle or a manually operated slider to the drive system, as is known for sliding roof systems of cars from the seventies. The upper point of articulation of the deployment lever can be coupled to the support bar directly by a pivot pin of the deployment lever engaging directly in a slide groove of the support bar or indirectly by this point of articulation engaging on a slider which engages around a slide web of the support bar.

In an embodiment of the invention, a stationary hinge point, assigned to the stationary bearing section, of the control lever is positioned above the lower point of articulation of the deployment lever. In addition, in a further embodiment of the invention, a hinge point, assigned to the deployment lever, of the control lever is positioned between the lower point of articulation and the upper point of articulation of the deployment lever. The control lever consequently points downward in the rest position of the deployment lever. In the deployed position of the deployment lever, the control lever is preferably pivoted as far as approximately a position which is at least largely horizontal and extends parallel to the longitudinal extent of the guide rail assembly. Advantageous force conditions consequently result for the control lever in the region of its two hinge points, as a result of which the forced control by means of the control lever has a long-lasting design.

In a further embodiment of the invention, in its rest position the deployment lever is positioned so that it is inclined with respect to the guide rail assembly in such a way that the upper point of articulation is positioned higher, relative to a base of the guide rail assembly, than the lower point of articulation. An inclined and hence oblique orientation consequently results for the rest position of the deployment lever too, which requires only low forces for raising in the direction of the deployed position.

In a further embodiment of the invention, in the rest position of the deployment lever the control lever is oriented at least largely vertically downward such that the stationary hinge point of the control lever and the hinge point assigned to the deployment lever are positioned at least largely above each other vertically. When the deployment carriage for transferring the deployment lever is shifted in the direction of the deployed position, favorable force conditions consequently result between the control lever and the deployment lever which enable a reliable and smooth deployment of the deployment lever.

In a further embodiment of the invention, the guide rail assembly has a separately manufactured rail component on which the deployment carriage is mounted displaceably and which carries the bearing section for the control lever. When mounted, the rail component is part of the guide rail assembly. The rail component has a guide surface relative to which the deployment carriage is mounted so that it can slide. Separate manufacture of this rail component enables a pre-assembled unit for the rear deployment mechanism to be formed. The rail component can be provided with at least one stop means for limiting the ability of the deployment carriage to move linearly. The guide surface of the separately manufactured rail component can be arranged in a plane which is flush with a corresponding guide surface of the extension, adjoining it at the front, of a front rail section of the guide rail assembly or in a plane which is offset with respect to the guide surface of the front part of the guide rail assembly.

In a further embodiment of the invention, the rail component has a side wall in which a coupling profile is mounted displaceably which can be coupled at a front end region to a driven control carriage of the control mechanism and which is connected positively at a rear end region to the deployment carriage. The coupling profile is preferably designed as an elongated bar or rod and is formed at its front end region either so as to be guided together with the control carriage serving as a drive carriage or so as to be secured in a stationary fashion on a corresponding retaining section of the guide rail assembly. Securing this coupling profile in a stationary fashion serves to immobilize the rear deployment carriage for the ventilation position, i.e. the deployed position, of the deployment lever. Carrying the coupling profile along together with the driven control carriage necessarily causes the deployment carriage to be displaced in order to lower the deployment lever out of the deployed position and in the direction of the rest position or to transfer the deployment lever from the rest position in the direction of the deployed position, depending on the direction of displacement.

In a further embodiment of the invention, the rail component is configured as a plastic component on which the side wall and the bearing section are integrally formed. As a result, the rail component is manufactured as an integral component which reduces the manufacturing complexity and manufacturing costs. In addition, the plastic component has a light weight compared with metal parts, which enables an overall reduction in weight for the drive system.

For the spoiler roof assembly of the type mentioned at the beginning, the object on which the invention is based is achieved by the features of claim 9. The spoiler roof assembly is particularly advantageously provided for a car. In addition, the spoiler roof assembly preferably has roof surface parts which are transparent at least in places in order to give the interior of the car a bright and airy sense of space. Appropriate roof surface parts include both the at least one movable roof part and at least one further preferably fixed roof section.

Further advantages and features of the invention result from the claims and the following description of a preferred exemplary embodiment of the invention which is illustrated with the aid of the drawings.

### BRIEF DESCRIPTION OF THE DRAWINGS

FIG. 1 shows a perspective view of a roof region of a car with an embodiment of a spoiler roof assembly according to the invention which is provided with two drive systems according to the invention;

FIG. 2 shows a perspective view of an embodiment of a drive system according to the invention for the spoiler roof assembly according to FIG. 1 in a closed position of a movable roof part of the spoiler roof assembly;

FIG. 3 shows an enlarged view of a rear deployment mechanism of the drive system according to FIG. 2;

FIG. 4 shows a further perspective view of the rear deployment mechanism according to FIG. 3, but in a different plane of section such that a side wall of a rear rail component of a guide rail assembly of the drive system can also be seen;

FIG. 5 shows a further perspective view of the drive system according to FIG. 2 in an open position of a support bar;

FIG. 6 shows a perspective view of the rear deployment mechanism of the drive system according to FIG. 2 in the open position of the support bar; and

FIG. 7 shows a further perspective view of the rear deployment mechanism obliquely from above and from the rear.

### DETAILED DESCRIPTION

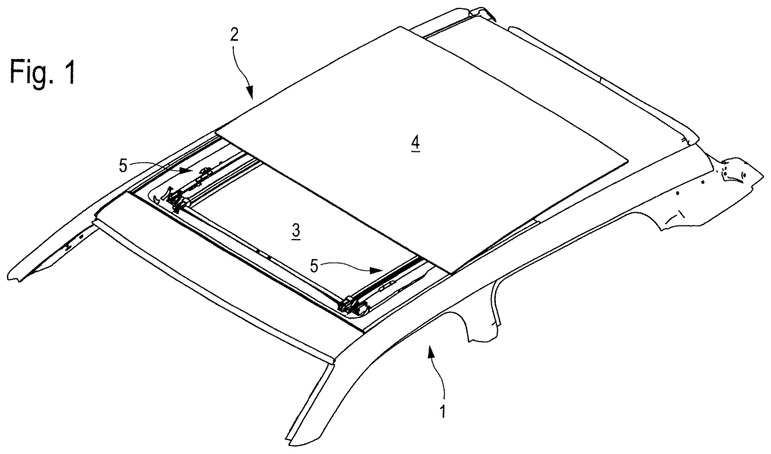

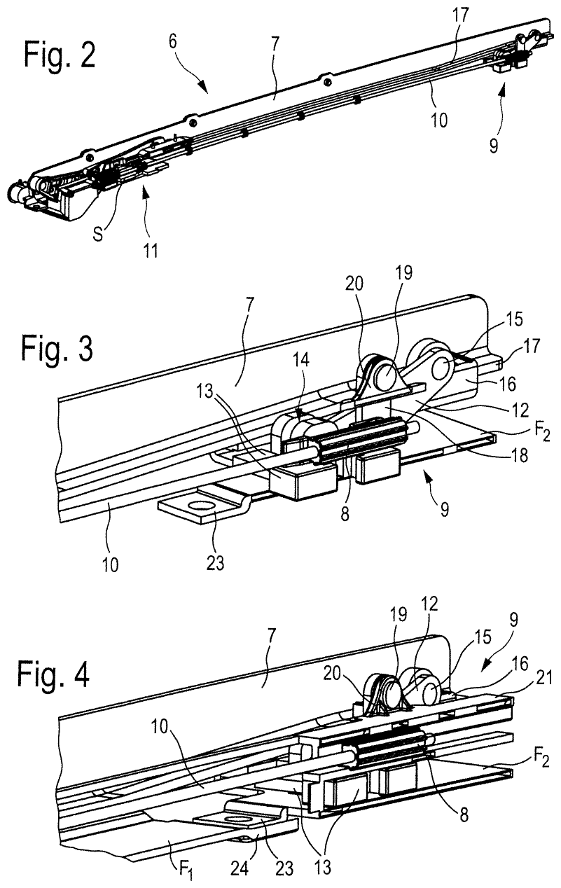

A car 1 has, according to FIG. 1, a spoiler roof assembly 2 in a roof region of the car 1. The spoiler roof assembly 2 is provided with a movable roof part 4 which is provided for sealing shut or unblocking a roof opening 3 into the interior of the vehicle. In an open position which is illustrated in FIG. 1, the movable roof part 4 is shifted backward above a fixed roof section (not described in detail). Both the movable roof part 4 and the fixed roof section are configured to be at least largely transparent. The movable roof part 4 is designed as a glass roof part. The fixed roof section is also configured as a glass roof part. The movable roof part 4 is provided on opposite longitudinal sides, i.e. on sides which extend in the longitudinal direction of the vehicle, in the region of its underside with retaining means which form a connection of the roof part 4 to two drive systems 5 which are provided for shifting the roof part 4 between the closed position which seals shut the roof cut-out 3, a ventilation position, and an open position according to FIG. 1. The two drive systems 5 are provided on opposite longitudinal sides of the roof cut-out 3 on a support frame which is rigidly connected to the roof region of the car 1. The two drive systems 5 are driven synchronously with respect to each other via a central drive unit in a manner not described in detail in order to enable the desired shifting of the roof part 4 between the closed position, the ventilation position, and the open position. One of the two drive systems 5 is described below with the aid of FIGS. 2 to 7. The opposite drive system 5 is configured identically apart from a mirror-symmetrical arrangement relative to a vertical central longitudinal plane of the car.

The drive system 5 has a control mechanism 6 which is mounted in a guide rail assembly Fₗ, F₂. The control mechanism 6 serves to shift a support bar 7 between the closed position, the ventilation position, and the open position of the roof part 4. The support bar 7 is rigidly connected in the region of the underside of the roof part 4 to retaining means, assigned to the corresponding longitudinal side, of the roof part 4 such that shifting the support bar 7 necessarily also causes the roof part 4 to be shifted correspondingly. The support bar 7 is connected to the control mechanism 6 in a hinged fashion. The support bar 7 is here coupled with a front end region to a front deployment mechanism 11 and via a slide web 17 to a rear deployment mechanism 9. The control mechanism 6 has a driven control carriage S which is connected in a manner not described in detail to a high-tensile and compression-resistant drive cable which is driven by the drive unit so that it moves linearly via a suitable gear. The control carriage S, driven by the drive cable, is guided in the guide rail assembly Fₗ, F₂ so that it can be displaced longitudinally forward and backward in the longitudinal direction of the vehicle.

The rear deployment mechanism 9 has a deployment carriage 13 which is guided so that it can be displaced longitudinally in a rear rail section F₂ of the guide rail assembly Fₗ, F₂ in the longitudinal direction of the guide rail assembly Fₗ, F₂. For this purpose, the deployment carriage 13 is provided with sliding elements which are not described in detail. A bearing block 14 for pivotably mounting a lower point of articulation of a deployment lever 12 is provided on the deployment carriage 13 and defines a lower pivot axis for the deployment lever 12 which extends in the transverse direction of the vehicle. Opposite the lower point of articulation in the region of the bearing block 14, the deployment lever 12 has an upper point of articulation 15 which couples the deployment lever 12 in the region of its upper end pivotably to a control slider 16. The pivot axis defined by the upper point of articulation 15 is parallel to the pivot axis of the lower point of articulation of the deployment lever 12. The control slider 16 engages around the slide web 17 in a rear region of the support bar 7 such that the support bar 7 is guided so that it can slide in the region of the control slider 16 in the longitudinal direction of the vehicle.

The rear rail section F₂ configured as a separate rail component has at least one fastening tab 23 by means of which the rear rail section F₂ is rigidly connected, during the mounting of the spoiler roof assembly 2, to a complementary fastening tab 24 of the front rail section F₁ of the guide rail assembly F₁, F₂. Mechanical fastening elements (not illustrated) are provided for this purpose. A guide tab of the rear rail section F₂ for the deployment carriage 13 is, in the view in FIG. 4, positioned slightly above a plane which forms a guide surface for the control carriage S of the front rail section F₁.

The deployment carriage 13 is coupled to the driven control carriage S via a coupling profile 10 for displacement along the rear rail section F₂ of the guide rail assembly Fₗ, F₂. The coupling profile 10 forms an elongated high-tensile and compression-resistant rod which is guided so that it can be displaced longitudinally in a corresponding guide channel of the guide rail assembly Fₗ, F₂. The coupling profile 10 is provided at its rear end region 8 with a catch 25 (FIG. 7) which engages positively in a receptacle, formed by two stops 26, of the deployment carriage 13. In a ready-to-use operating state, the rear end 8 of the coupling profile 10 is permanently connected to the deployment carriage 13.

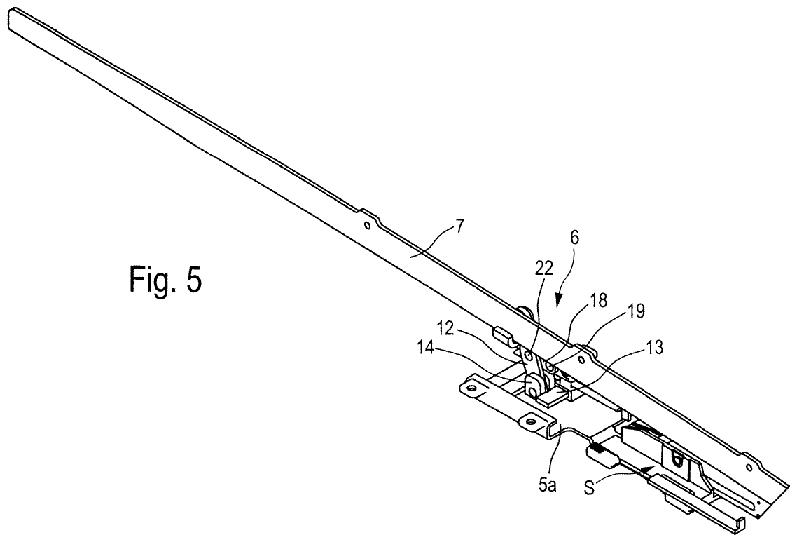

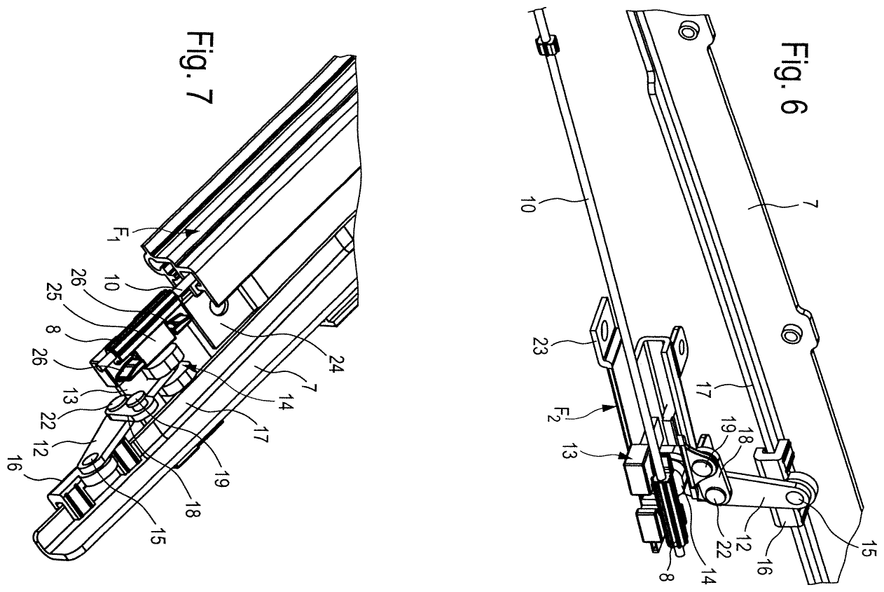

The coupling profile 10 is detachably connected at its front end region to the control carriage S. Depending on the position of the control carriage S, the front end region of the coupling profile 10 is alternatively separated from the control carriage S and connected to a retaining means which is fixed to the guide rail, or is detached again from this retaining means and reconnected to the control carriage S. As a result, the control carriage S can, depending on the corresponding position of the coupling profile 10, carry along the rear deployment carriage 13 for a limited amount of displacement travel. The limited amount of displacement travel serves to displace the deployment carriage 13 between two positions in which the deployment lever 12 is situated in its rest position (see FIGS. 2 to 4 and 7) or is situated in its deployed position which can be seen with the aid of FIGS. 5 and 6.

In order to effect a forced upward or downward pivoting movement of the deployment lever 12 in the case of a corresponding shifting movement of the deployment carriage 13, forced control in the form of a control lever 18 is assigned to the deployment lever 12, said control lever 18 being connected pivotably to the deployment lever 12 in the region of a hinge point 22 on the latter and connected pivotably in the region of a stationary hinge point 19 to a bearing section 20 which is arranged fixedly on the rear rail section F₂ of the guide rail assembly Fₗ, F₂. The bearing section 20 sits on top of a side wall 21 of the rail section F₂. This bearing section 20 is positioned above the upper point of articulation 15 of the deployment lever 12 in the rest position of the deployment lever 12, as can be seen in FIGS. 3 and 4. In this rest position of the deployment lever 12, the stationary hinge point 19 of the control lever 18 and the lever-side hinge point 22 of the control lever 18 are positioned vertically above each other, as can be clearly seen in FIGS. 3 and 7.

The rail section F₂ is configured as a plastic component which is manufactured separately from the front rail section F₁ of the guide rail assembly Fₗ, F₂, wherein the side wall 21 is an integral part of the rail section F₂. The side wall has a guide channel (not described in detail) for the sliding elements of the deployment carriage 13, wherein, as can be seen in FIG. 4, this guide channel is provided with a stop rim (not described in detail) which faces the front rail section F₁ and limits the ability of the sliding elements of the deployment carriage 13 to slide forward. In addition, the side wall has a further guide channel for a sliding sleeve of the coupling profile 10.

If the control carriage S is then displaced backward out of the closed position of the roof part 4 and hence out of the closed position of the support bar 7 along the guide rail assembly Fₗ, F₂, by virtue of the coupling of the coupling profile 10 to the deployment carriage 13, the rear deployment carriage 13 is also displaced backward on the rail section F₂ in the region of its guide surface. Because of the stationary mounting of the control lever 18 in the manner of a four-bar linkage, the control lever 18 is pivoted backward and upward by the movement of the deployment carriage 13 and the movement of the deployment lever 12, wherein, by virtue of the coupling of the control lever 18 to the deployment lever 12, the deployment lever 12 is forced to be raised in the direction of its deployed position according to FIG. 6. The rear region of the support bar 7 is consequently raised, as a result of which the roof part 4 is transferred into its ventilation position. In this ventilation position, the front end region of the coupling profile 10 is uncoupled from the control carriage S and connected to the stationary retaining means of the guide rail assembly Fₗ, F₂ such that the coupling profile 10 which is now fixed on the rail side also immobilizes the deployment carriage 13 in the position in which the deployment lever 12 has reached its deployed position. By further displacement of the control carriage S, the support bar 7 can now be displaced backward along the control slider 16, wherein the front end section of the support bar 7 is also shifted upward simultaneously via the front deployment mechanism 11 which is carried along by the control carriage S. The shifting of the front end section of the support bar 7 vertically is, however, less than the shifting of the support bar 7 vertically in the region of the rear slide web 17 such that the support bar 7 and hence also the roof part 4 maintain an oblique position which rises backward and upward in the open position of the roof part 4 too. To return the roof part 4 from the open position in the direction of the closed position, the control carriage S is driven in the opposite direction such that the control carriage S is displaced forward. As soon as the control carriage S has reached the front end section of the coupling profile 10 again, the coupling profile 10 is carried along again, as a result of which the deployment carriage 13 is displaced forward again into its original starting position. Consequently, the lower point of articulation of the deployment lever 12 is also forced to move forward again, as a result of which the deployment lever 12 is lowered again in the direction of its rest position by virtue of the forced guidance by means of the control lever 18.

1. A drive system for a spoiler roof assembly of a motor vehicle, with a support bar which can be connected to a movable roof part with a control mechanism which engages on the support bar in order to shift the support bar between a closed position, a ventilation position, and an open position, and with a guide rail assembly which is in a ready for use state fixed to the vehicle and in which the control mechanism is guided so that it can be displaced longitudinally, wherein the control mechanism has a rear deployment lever which is coupled to the support bar by an upper point of articulation and is mounted, so that it can pivot between a rest position and a deployed position, on a deployment carriage which can be displaced along the guide rail assembly, wherein a mechanical forced control is assigned to the deployment lever and shifts the deployment lever between the rest position and the deployed position depending on a displacement of the deployment carriage,
wherein the mechanical forced control is formed by a control lever which is mounted so that it can pivot at one end on the deployment lever and at the other end on a bearing section which is stationary with respect to the guide rail assembly.

2. The drive system as claimed in claim 1, a stationary hinge point assigned to the stationary bearing section , of the control lever is positioned above lower point of articulation of the deployment lever. 3. (Currently Amended) The drive system-fh-*- as claimed in claim 2, where 1 a hinge point assigned to the deployment lever, of the control lever is positioned between the lower point of articulation and the upper point of articulation of the deployment lever H-3K

4. The drive system as claimed in claim 1 where i Ivha-h-, in its rest position the deployment lever is positioned so that it is inclined with respect to the guide rail assembly in such a way that the upper point of articulation is positioned higher, relative to a base of the guide rail assembly than a&hfc lower point of articulation of the deployment, lever.

5. The drive system-as claimed in that, in the rest position of the deployment lever-the control lever--H-S-h is oriented at least largely vertically downward such that at-he stationary hinge point f4-Sf of the control lever and athe hinge point assigned to the deployment lever are positioned at least largely above each other vertically.

6. The drive system as claimed in claim lortor-of--the-preeed, whereithat- the guide rail assembly has a separately anufactured rail component on which the deployment carriage-(4r3r is mounted displaceably and which carries the bearing section for the control lever

7. The drive system-45 as claimed in claim 6, the rail componenthas a side wall in which a coupling profile-(44r is mounted displaceably which can be coupled at a front end region to a driven control carriage--fSr of the control mechanism-and which is connected positively at a rear end region (Ft to the depyment carr iage

8. The drive system as claimed in claim 6-e* 7, the rail component is configured as a plastic component on which he side wall of the rail component-and the bearing section-are integrally formed.

9. A spoiler roof assembly for a motor vehicle with at least one drive system as claimed in claim
